(19) United States
(12) Patent Application Publication
(10) Pub. No.: US 2004/0238002 A1
(43) Pub. Date: Dec. 2, 2004

(54) Method of producing a glass substrate for a magnetic disk and method of producing a magnetic disk

(75) Inventors: Hirotaka Tanaka, Nirasaki-shi (JP); Yoshihiro Tawara, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/790,111

(22) Filed: Mar. 2, 2004

(30) Foreign Application Priority Data
Mar. 3, 2003 (JP) 56274/2003

(51) Int. Cl. B08B 7/00

(52) U.S. Cl. 134/6

(57) ABSTRACT

In a method of producing a glass substrate for a magnetic disk, a principal surface of a glass substrate is subjected to polishing in order to impart a texture thereon. Thereafter, a treating liquid is supplied onto the principal surface of the glass substrate. While a tape is pressed against the principal surface of the glass substrate, the principal surface is cleaned.

This application claims priority to Japanese patent application JP 2003-56274, the disclosure of which is incorporated herein by reference.

### BACKGROUND OF THE INVENTION

This invention relates to a method of producing a glass substrate for a magnetic disk for use in a HDD (hard disk drive) or the like.

At present, following the rapid development of the IT industry, the information recording technology, in particular, the magnetic recording technology is requested to achieve dramatic technical innovation. For a magnetic disk to be loaded in a HDD or the like, it is required to develop a technology capable of achieving an information recording density of 40 Gbit/inch² to 100 Gbit/inch² or more in response to a demand for a higher capacity.

The magnetic disk is required to be particularly excellent in magnetic characteristic in a flying/traveling direction of a magnetic head. To this end, there is known a technique of forming a texture on a surface of a substrate for a magnetic disk to impart a magnetic anisotropy to a magnetic layer, thereby improving the magnetic characteristic as a magnetic recording medium to achieve a higher recording density as described in, for example, Japanese Patent Application Publication (JP-A) No. 2002-30275.

In the meanwhile, attention is recently drawn to a glass substrate as a substrate for a magnetic disk, which is suitable for a higher recording density. The glass substrate has a high rigidity as compared with a metal substrate and is therefore suitable for an increase in rotation speed of a magnetic disk apparatus. Further, the glass substrate makes it easy to lower a flying height of a magnetic head because a flat and smooth surface is obtained. Therefore, the glass substrate is advantageous in an improvement of a S/N ratio of a recording signal and an increase in recording density.

However, in case where the texture is formed on the surface of the glass substrate as described in the above-mentioned publication and if a magnetic disk produced from the glass substrate is mounted to the HDD, there is a problem of easy occurrence of a head crash defect and a thermal asperity (TA) defect. These defects (failures in the HDD) have a high tendency to occur after lapse of some time after the HDD is brought into market and installed in a PC (personal computer) or the like. Therefore, occurrence of these defects will lead to significant downfall of creditworthiness in the market. This inhibits wide spread of the glass substrate for a magnetic disk, which is capable of achieving a higher recording density.

### SUMMARY OF THE INVENTION

Therefore, it is an object of this invention to provide a glass substrate for a magnetic disk, which is capable of preventing occurrence of a head crash defect and a thermal asperity defect even if a texture is formed by polishing a surface of the glass substrate by the use of a tape and which is suitable for a higher recording density.

The present inventors investigated a reason for occurrence of the head crash defect and the thermal asperity defect mentioned above in case where a magnetic disk is produced by the use of a disk substrate provided with a texture formed by polishing a surface of a glass substrate with a tape and the magnetic disk is mounted to an HDD. As a result, it has been found out that a small amount of contamination is often adhered to a surface of a magnetic head mounted to the HDD in which those defects have occurred.

In order to investigate a reason for production of the contamination, a texture was formed on the surface of the glass substrate by the use of a tape under various conditions. As a result, it has been revealed that, in presence of specific disturbance in texture profile on the surface of the glass substrate, similar disturbance in texture profile will be caused on a surface of the magnetic disk produced by the use of the glass substrate, promoting the production of the contamination on the magnetic head.

FIG. 3 shows an example of the texture profile formed on the surface of the glass substrate. In FIG. 3, it is confirmed that a single line or streak of texture is higher by several nanometers than a surrounding texture profile. It has been found out that, if such disturbance as shown in FIG. 3 is present in the texture profile, contamination tends to be attached to the magnetic head.

Even if small unevenness in height on the order of several nanometers is present in the texture profile as shown in FIG. 3, such unevenness is sufficiently smaller than the flying height of the magnetic head and, therefore, has not been recognized as a problem so far. However, as a result of study by the present inventors, it has been found out that the head crash defect and the thermal asperity defect may be caused through the production of contamination on the magnetic head.

According to the study by the present inventors, the reason why the disturbance in texture profile is caused on the glass substrate is considered as follows.

Specifically, the glass substrate has a high hardness and is hard as compared with a substrate having a metal surface. Therefore, when the glass substrate is polished with a tape to form a texture, the texture is often disturbed by biting of abrasive grains or small foreign matters. Further, since the glass substrate is an insulator, such biting is difficult to eliminate because of an electrostatic force generated by friction during polishing with the tape. It is considered that the disturbance in texture profile is caused by the above-mentioned reasons.

Based on a series of findings and considerations mentioned above, the present inventors completed the invention having the following aspects.

(First Aspect)

A method of producing a glass substrate for a magnetic disk, comprising:

polishing a principal surface of a glass substrate to impart a texture thereon;

thereafter supplying a treating liquid onto the principal surface of the glass substrate; and

pressing a tape against the principal surface of the glass substrate and moving the glass substrate and the tape relative to each other to clean the principal surface.

(Second Aspect)

A method of producing a glass substrate for a magnetic disk according to the first aspect, wherein the treating liquid is pure water.

(Third Aspect)

A method of producing a glass substrate for a magnetic disk according to the first aspect, wherein the treating liquid contains colloidal particles.

(Fourth Aspect)

A method of producing a glass substrate for a magnetic disk according to the first aspect, wherein the tape for cleaning the principal surface of the glass substrate has small foaming pores at least on its surface.

(Fifth Aspect)

A method of producing a glass substrate for a magnetic disk according to the first aspect, wherein the glass substrate is a chemically strengthened glass substrate.

(Sixth Aspect)

A magnetic disk is produced by forming at least a magnetic layer on a glass substrate for a magnetic disk obtained by the method according to the first aspect.

(Seventh Aspect)

In the method of producing a glass substrate for a magnetic disk according to the first aspect, the glass substrate is used as a magnetic disk for a load/unload system.

As set forth in the first aspect, a method of producing a glass substrate for a magnetic disk according to this invention includes polishing a principal surface of a glass substrate to impart a texture thereon, thereafter supplying a treating liquid to the principal surface of the glass substrate, and cleaning the principal surface with a tape.

By the use of the tape as a cleaning member, it is possible to remove abrasive grains or foreign matters adhered to the principal surface of the substrate during the texturing step. Simultaneously, disturbance of the texture formed on the surface of the glass substrate is reduced by an appropriate pressing force applied to the principal surface of the substrate during cleaning with the tape. Further, by successively feeding the tape forward, a pure cleaning member (tape) is continuously supplied onto the principal surface of the substrate. Therefore, the foreign matters and the like, which have once been removed by cleaning with the tape, can not be adhered again. In the above-mentioned manner, a uniform texture can be formed on the glass substrate.

As a cleaning method used in cleaning with the tape, which is executed after the texture is formed on the principal surface of the glass substrate, a single-substrate tape cleaning method is preferably used. For example, such tape cleaning method may be a rotary tape cleaning method. In the rotary tape cleaning method, a specific tape is supplied onto and pressed against the surface of a disk-shaped glass substrate which is rotating. Thus, the surface of the glass substrate can be cleaned with high precision.

The tape used in the above-mentioned cleaning may be same as a tape used in texturing. However, use of a different tape enables a more uniform texture to be formed and is therefore preferable. This is because, to the tape which has been used in texturing, a slurry used in texturing and other foreign matters may be adhered. Therefore, it is preferable to prepare a different tape, i.e., a cleaning tape different from the tape for texturing and to carry out cleaning with the tape.

Herein, a tape having a surface provided with very small foaming pores is preferably used as the cleaning tape. In this case, the cleaning tape may be a tape provided with very small foaming pores formed on its surface or a tape provided with very small foaming pores formed at least on its surface, with a core member made of a different material. For example, a tape having a surface comprising a foamed resin such as foamed polyurethane is preferable because very small foaming pores are formed on the surface and a function of uniformizing the texture during cleaning with the tape is enhanced. Preferably, each foaming pore has a diameter between 20 μm and 100 μm because a cleaning effect during cleaning with the tape is increased and the function of uniformizing the texture is enhanced.

In this invention, a treating liquid is supplied between the tape and the glass substrate when the principal surface of the glass substrate is cleaned with the tape. As the treating liquid, for example, pure water is preferably used. By supplying the pure water, it is possible to prevent adhesion of foreign matters during cleaning so that a uniformly textured surface is formed. As the pure water, use may be made of ultra pure water, such as RO water (reverse osmosis water, RO: Reverse Osmosis) or DI water (deionization water, DI: DeIonization). In particular, use of the DI water subjected to deionization is preferable because disturbance in morphology of a fine texture profile is suppressed.

Preferably, the above-mentioned treating liquid in this invention is adjusted to be neutral or alkaline. If adjusted to be alkaline, a cleaning effect by a glass etching function is utilized in combination. Therefore, as compared with the case where the treating liquid is neutral, a higher cleaning effect is achieved. However, in case where maintenance of morphology of the texture profile is regarded important, it is preferable to adjust the treating liquid to be neutral without the glass etching function. Thus, it is preferable to adjust the treating liquid depending upon the purposes, i.e., to adjust the treating liquid to be alkaline in case where a higher cleaning effect is required even if the morphology of the texture profile is slightly varied and to be neutral in case where maintenance of the morphology of the texture profile is desired although the cleaning effect is slightly lowered. In order to adjust the treating liquid to be alkaline, a chemical solution such as sodium hydroxide or potassium hydroxide may be added. Specifically, the treating liquid is appropriately adjusted so that PH falls within a range between 7 and 12.

In this invention, the treating liquid preferably contains colloidal particles.

It is preferable to contain the colloidal particles because it is possible to enhance a function of removing burrs of the glass formed during texturing polishing and unevenness of the texture illustrated in FIG. 3. Advantageously, it is also possible to achieve a function of removing contamination such as an organic substance adhered onto the glass substrate. The colloidal particles preferably have a small particle size. For example, the colloidal particles having an average particle size between 0.01 μm and 0.5 μm are preferably used.

As the colloidal particles, colloidal silica particles may be used. The colloidal silica particles are particularly preferable because the glass substrate can be highly purified.

In case where the colloidal silica particles are contained in the treating liquid, the treating liquid is preferably adjusted to be alkaline. By adjusting the treating liquid to be alkaline, the above-mentioned advantageous function can be achieved. Specifically, the treating liquid is preferably adjusted so that PH falls within a range between 8 and 12.

In case where cleaning with the tape is carried out using the treating liquid containing the colloidal particles, cleaning with the tape may thereafter be carried out using a treating liquid which does not contain the colloidal particles but comprises, for example, pure water. In this event, it is possible to prevent the colloidal particles from being left on the glass substrate.

In this invention, cleaning with the tape is advantageously followed by scrub cleaning. By carrying out the scrub cleaning, it is possible to more highly purify the surface of the glass substrate. Further, it is possible to reliably prevent the colloidal particles from being left on the glass substrate in case where the treating liquid used in cleaning with the tape contains the colloidal particles. In case where the scrub cleaning is carried out, it is preferable to supply a neutral or an alkaline cleaning liquid. Specifically, it is preferable to adjust the cleaning liquid so that PH falls within a range between 7 and 12.

As a glass for the glass substrate in this invention, use may be made of an aluminosilicate glass, a soda lime glass, or the like. The aluminosilicate glass is preferable because a high rigidity is obtained if it is treated into a chemically strengthened glass.

Use may be made of an amorphous glass or a crystallized glass comprising an amorphous component and a crystalline component. If the amorphous glass is used, the function of this invention is advantageously achieved.

The above-mentioned glass preferably comprises, as an amorphous aluminosilicate glass, an aluminosilicate glass containing 58-75 wt % SiO₂, 5-23 wt % Al₂O₃, 3-10 wt % Li₂O, and 4-13 wt % Na₂O as main components.

Further, the glass substrate preferably comprises an aluminosilicate glass containing 62-75 wt % SiO₂, 5-15 wt % Al₂O₃, 4-10 wt % Li₂O, 4-12 wt % Na₂O, and 5.5-15 wt % ZrO₂ as main components, with the weight ratio of Na₂O/ZrO₂ being 0.5-2.0 and the weight ratio of Al₂O₃/ZrO₂ being 0.4-2.5.

In order to avoid occurrence of protrusions on the surface of the glass substrate as a result of an undissolved portion of ZrO₂, use is preferably made of a chemically strengthenable glass containing, by mol %, 57-74% SiO₂, 0-2.8% ZnO₂, 3-15wt % Al₂O₃, 7-16 wt % Li₂O, and 4-14 wt % Na₂O.

By chemically strengthening, the above-mentioned aluminosilicate glass is improved in transverse strength, increased in depth of a compressive stress layer, and excellent in Knoop hardness. A chemically strengthening method is not specifically limited but may be any chemically strengthening method known in the art. Practically, however, chemical strengthening by low-temperature ion exchange is preferable.

In case where the above-mentioned chemically strengthened glass substrate is used as the glass substrate, polishing for imparting the texture is preferably carried out after a chemically strengthening step. To form the texture before the chemically strengthening step is not preferable because the texture profile may be disturbed during ion exchange in the chemically strengthening step. If the texture is imparted onto the glass substrate after it is chemically strengthened and a compressive stress is produced on its surface, a fine and elaborate texture is obtained.

A diameter of the glass substrate is not particularly limited. Practically, however, for a small-sized magnetic disk which is not greater than a 2.5-inch magnetic disk and which is often used as a mobile HDD, this invention is highly useful because it is possible to provide a glass substrate for a magnetic disk, which is high in shock resistance and which is capable of achieving a higher recording density.

The glass substrate preferably has a thickness between 0.1 mm and 1.5 mm. In particular, in case of a magnetic disk comprising a thin substrate having a thickness on the order of 0.1 mm to 0.9 mm, this invention is highly useful and advantageous because it is possible to provide a glass substrate for a magnetic disk which is high in shock resistance.

In the method of producing a glass substrate for a magnetic disk according to this invention, a single-substrate tape texturing method is preferably used in order to form a texture by polishing with the tape.

As the single-substrate tape texturing method, a rotary tape texturing method may be used for example. In the rotary tape texturing method, a specific tape is fed onto and pressed against a surface of a disk-shaped glass substrate which is rotating and a polishing slurry such as a diamond slurry is supplied. Thus, a circumferential texture, for example, is formed on the surface of the glass substrate.

As an example of an apparatus for executing the rotary tape texturing method, use may be made of a tape texturing apparatus as illustrated in FIG. 1 (schematic diagram). The apparatus illustrated in FIG. 1 is used in examples which will later be described. In the tape texturing apparatus, a glass substrate 1 fixed to a spindle 101 is rotated and an abrasive is supplied through a slurry (abrasive grains) dropping port 102 to tapes 103. Opposite surfaces of the glass substrate 1 are clamped by the tapes 103 wound around rollers 104. Thus, a circumferential texture is formed on each principal surface of the glass substrate 1. The rollers 104 with the tapes 103 wound therearound are rotated at a predetermined rotation speed so that a new surface of each tape 103 is continuously contacted with the glass substrate 1. In this case, the spindle 101 can be wobbled. Plate-like members 105, 105 fixed to shafts of the rollers 104 are moved around a support point a so that the glass substrate 1 is clamped. At this time, a load applied to the glass substrate 1 is determined by a force of a spring 106 extended between the plate-like members 105. The load is measured by a tension meter 107.

By adjusting a substrate rotation speed (spindle rotation speed) and a texturing time in this tape texturing apparatus, the profile of the texture on the glass substrate can be adjusted.

A material and a shape of the tape used in texturing is not particularly limited. A type of the tape may be a pile tape, a woven fabric tape, a nonwoven fabric tape, or the like. As a material of a tape fiber, use may be made of a plastic fiber such as polyester and nylon.

As the polishing slurry supplied in polishing for imparting the texture, a polishing slurry containing diamond abrasive grains is preferably used. Among others, a polishing slurry containing polycrystalline diamond abrasive grains is preferably used in view of stable polishing and texturing. It is advantageous that the diamond abrasive grains have an average particle size between 0.1 μm and 1 μm.

The texture in this invention is not specifically limited as far as a magnetic anisotropy in a disk circumferential direction is induced in a magnetic layer. For example, a circumferential texture, a spiral texture, and a cross texture may be used. Among others, the circumferential texture advantageously achieves the effect of this invention because a direction of the texture is similar to a traveling direction of a magnetic head flying and traveling over a magnetic disk.

As regards a surface roughness of the texture, a flat and smooth surface having Rmax of 5 nm or less and Rp of 3 nm or less is preferable. Such flat and smooth surface defined by the above-mentioned surface roughness contributes to a higher recording density of the magnetic disk.

In this invention, Rmax represents a maximum height and Rp represents a maximum peak height, both of which are defined in Japanese Industrial Standard (JIS).

By forming at least a magnetic layer on the glass substrate for a magnetic disk in this invention, a magnetic disk suitable for a higher recording density is obtained. If a Co-based magnetic layer having an hcp crystal structure is used as the magnetic layer, a high coercive force (Hc) is obtained to contribute to a higher recording density.

If necessary, an underlying layer is preferably formed between the glass substrate and the magnetic layer in order to control crystal grains of the magnetic layer and orientation thereof.

Upon production of the magnetic disk, at least a magnetic layer is preferably formed by DC magnetron sputtering using a fixed-target deposition method.

The glass substrate for a magnetic disk according to this invention is preferably used as a magnetic disk for a load/unload system. In case where the glass substrate is used as the magnetic disk for a load/unload system, it is possible to prevent occurrence of an unstable flying condition of the magnetic head due to fly stiction of the magnetic head which is specific to the load/unload system, and occurrence of a head crash defect and a thermal asperity defect resulting therefrom.

As regards the surface roughness of the texture in case where the glass substrate is used as the magnetic disk for a load/unload system, a flat and smooth surface having Rmax of 5 nm or less and Rp of 2.5 nm or less is preferable in order to improve a durability of the magnetic disk. In order to further improve the magnetic characteristic and the durability of the magnetic disk, a flat and smooth surface having Rp of 2.0 nm or less is preferable.

### BRIEF DESCRIPTION OF THE DRAWING

FIG. 1A is a side view showing one example of a tape texturing apparatus.

FIG. 1B is a perspective view showing the one example of the tape texturing apparatus.

FIG. 2 is a view showing a profile of a principal surface of a magnetic disk obtained in an example of this invention as observed by an AFM.

FIG. 3 is a view showing a profile of a principal surface of a glass substrate for a magnetic disk obtained in a comparative example as observed by the AFM.

### DESCRIPTION OF THE PREFERRED EMBODIMENTS

Now, description will be made of embodiments of this invention in conjunction with specific examples. It is noted here that this invention is not limited to the following example.

### EXAMPLE 1

A glass substrate for a magnetic disk in this example is a glass disk substrate for a magnetic disk, which is obtained by forming a texture by tape polishing on a principal surface of an amorphous aluminosilicate glass disk substrate chemically strengthened and thereafter cleaning the principal surface by tape cleaning.

Specifically, the glass substrate for a magnetic disk in this example was produced through (1) a rough lapping step (rough grinding step), (2) a shaping step, (3) a fine lapping step (fine grinding step), (4) an end face mirror-polishing step, (5) a principal surface mirror-polishing step, (6) a chemically strengthening step, (7) a texturing polishing step, and (8) a tape cleaning step.

(1) Rough Lapping Step

A disk-shaped glass substrate comprising an aluminosilicate glass and having a diameter of 66 mmφ and a thickness of 1.5 mm was obtained from a molten glass by direct pressing using an upper die, a lower die, and a body die. The disk-shaped glass substrate may be obtained by cutting, with a grindstone, a sheet glass formed by a down drawing method or a floating method instead of the direct pressing. As the above-mentioned aluminosilicate glass, use was made of a chemically strengthened glass containing 58-75 wt % SiO₂, 5-23 wt % Al₂O₃, 3-10 wt % Li₂O, and 4-13 wt % Na₂O. Next, the glass substrate was subjected to a lapping step for improving a dimensional accuracy and a profile accuracy. The lapping step was carried out by the use of a double-sided lapping apparatus and abrasive grains having a particle size of #400. In detail, opposite surfaces of the glass substrate received in a carrier were lapped to a surface accuracy of 0-1 μm and a surface roughness (Rmax) of about 6 μm by using alumina abrasive grains having a particle size of #400 at first, setting a load of about 100 kg, and rotating a sun gear and an internal gear of the lapping apparatus.

(2) Shaping Step

Then, a center portion of the glass substrate was bored by the use of a cylindrical grindstone and an outer peripheral end face was ground to reduce a diameter to 65 mmφ. Thereafter, the outer peripheral end face and an inner peripheral end face were subjected to predetermined chamfering. At this time, each end face of the glass substrate had a surface roughness of about 4 μm in Rmax. Generally, in a 2.5-inch HDD (hard disk drive), a magnetic disk having an outer diameter of 65 mm is used.

(3) Fine Lapping Step

Next, the abrasive grains were changed into those having a particle size of #1000 and the surfaces of the glass substrate were lapped to obtain the surface roughness of about 2 μm in Rmax and about 0.2 μm in Ra. The glass substrate after the lapping step was successively dipped into cleaning tanks (applied with ultrasonic waves) respectively filled with a neutral detergent and water to be subjected to ultrasonic cleaning.

(4) End Face Mirror-Polishing Step

Then, by brush polishing, the end faces (inner peripheral and outer peripheral) of the glass substrate were polished while the glass substrate was rotated so that the surface roughness was equal to about 1 μm in Rmax and about 0.3 μm in Ra. The surfaces of the glass substrate after the end face mirror polishing step were cleaned with water.

(5) Principal Surface Mirror-Polishing Step

Next, in order to remove a flaw or a distortion left after the above-mentioned lapping step, a first polishing step was carried out by the use of a double-sided polishing apparatus. In the double-sided polishing apparatus, the glass substrate held by a carrier was interposed between and brought into tight contact with upper and lower surface tables with polishing pads attached thereto. The carrier was engaged with a sun gear and an internal gear. The glass substrate was clamped and pressed by the upper and the lower surface tables. Thereafter, a polishing liquid was supplied between the polishing pads and polished surfaces of the glass substrate and rotation was started. Consequently, the glass substrate was rotated and revolved on the surface tables so that the opposite surfaces were simultaneously polished. Hereinafter, the same apparatus was used as the double-sided polishing apparatus used in each specific example. In detail, the polishing step was performed by the use of a hard polisher (hard foamed urethane) as a polisher. As a polishing condition, the polishing liquid was RO water with cerium oxide (average particle size of 1.3 μm) dispersed therein as an abrasive, the load was equal to 100 g/cm², and the polishing time was 15 minutes. The glass substrate after the above-mentioned first polishing step was successively dipped into cleaning tanks respectively filled with a neutral detergent, pure water, pure water, IPA (isopropyl alcohol), and IPA (vapor dry) to be subjected to ultrasonic cleaning and then dried.

Next, by the use of a double-sided polishing apparatus of the type same as that used in the first polishing step mentioned above, a second polishing step was carried out after changing the polisher into a polishing pad of a soft polisher (suede). The second polishing step was mirror polishing intended to polish the principal surface of the glass substrate into a flat and smooth mirror-finished surface having a surface roughness of about 8 nm or less in Rmax while maintaining a flat surface obtained in the first polishing step mentioned above. As a polishing condition, a polishing liquid was RO water with cerium oxide (average particle size of 0.8 μm) dispersed therein, the load was equal to 100 g/cm², and the polishing time was 5 minutes. The glass substrate after the above-mentioned second polishing step was successively dipped into cleaning tanks respectively filled with a neutral detergent, pure water, pure water, IPA, and IPA (vapor dry) to be subjected to ultrasonic cleaning and then dried.

(6) Chemically Strengthening Step

Next, the glass substrate after the above-mentioned cleaning was chemically strengthened. The chemically strengthening step was carried out by preparing a chemically strengthening solution comprising a mixture of potassium nitrate and sodium nitrate, heating the chemically strengthening solution to 380° C., and dipping the glass substrate after cleaned and dried into the chemically strengthening solution for about 4 hours. The glass substrate after chemically strengthened was successively dipped into cleaning tanks respectively filled with sulfuric acid, a neutral detergent, pure water, pure water, and IPA, IPA (vapor dry) to be subjected to ultrasonic cleaning and then dried.

Then, the surface of the glass substrate after the above-mentioned cleaning was subjected to visual inspection and precise examination utilizing reflection, scattering, and transmission of light. As a result, no defect such as protrusions formed by adhered matters or flaws was found out on the surface of the glass substrate. Further, the surface roughness of the principal surface of the glass substrate obtained via the above-mentioned steps was measured by an atomic force microscope (AFM). As a result, the glass substrate for a magnetic disk having an ultra smooth surface having Rmax of 2.13 nm and Ra of 0.20 nm was obtained. The glass substrate had an outer diameter of 65 mm, an inner diameter of 20 mm, and a thickness of 0.635 mm.

(7) Texturing Polishing Step

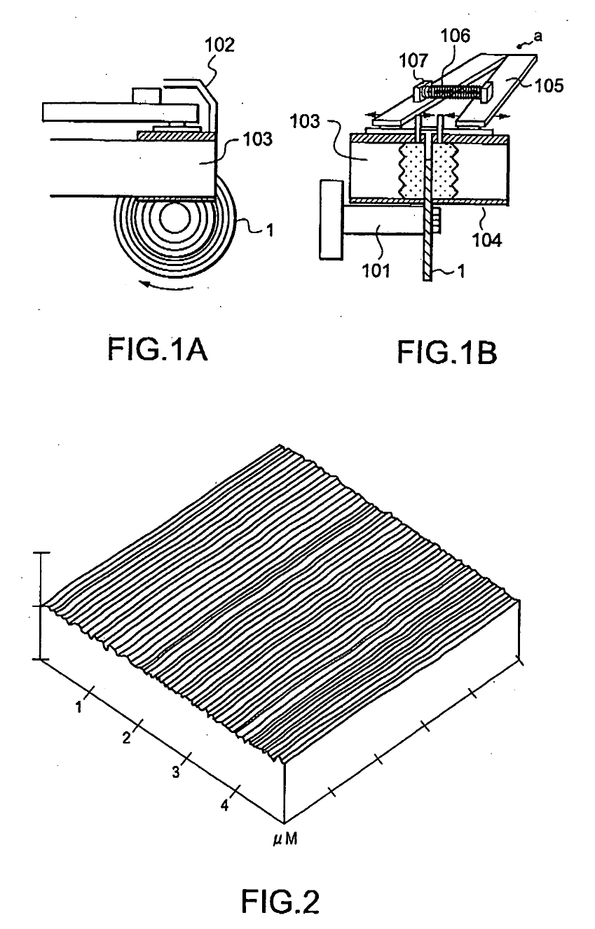

By the use of the above-mentioned single-substrate rotary tape texturing apparatus illustrated in FIG. 1, polishing and circumferential texturing were carried out.

As a tape, a polyester fiber fabric tape was used. As a hard abrasive, a slurry containing polycrystalline diamond having an average particle size of 0.125 μm dispersed in a dispersive agent was used.

A texturing polishing condition was as follows.

| | | |
|---|---|---|
| Working Pressure | 10 | g/mm² |
| Substrate Rotation Speed | 150 | rpm |
| Tape Feeding Speed | 3 | mm/sec |
| Texturing Time | 50 | seconds |

(8) Tape Cleaning Step

After a circumferential texture was formed on the principal surface of the glass substrate, the principal surface was subjected to tape cleaning.

Specifically, in an apparatus similar to the single-substrate rotary tape texturing cleaning tape apparatus used in the texturing polishing step mentioned above, a tape having a foamed polyurethane surface with a surface pore size of 40 μm in average was used and DI water comprising neutral ultra pure water was supplied instead of the polishing slurry. By such a single-substrate rotary tape cleaning apparatus having the above-mentioned structure, the principal surface of the glass substrate provided with the texture was rubbed and cleaned.

The pressure, the substrate rotation speed, the tape feeding speed, and the processing time in tape cleaning were similar to those in the texturing polishing step.

After the tape cleaning, the glass substrate was subjected to scrub cleaning by the use of a scrub pad. As a cleaning liquid, an alkaline cleaning liquid of PH 8 was used.

Next, the glass substrate for a magnetic disk obtained in this example was subjected to a deposition step mentioned below to obtain a magnetic disk.

By the use of a single-substrate sputtering apparatus, a seed layer, an underlying layer, a magnetic layer, a protection layer, and a lubrication layer were successively formed on the glass substrate provided with the texture.

As the seed layer, a first seed layer comprising a CrTi thin film (thickness 300 angstroms) and a second seed layer comprising an AlRu thin film (thickness: 400 angstroms) were formed. The underlying layer comprising a CrW thin film (thickness: 100 angstroms) was provided so as to improve a crystal structure of the magnetic layer. The CrW thin film has a composition of Cr: 90 at % and W: 10 at %.

The magnetic layer comprises a CoPtCrB alloy and has a thickness of 200 angstroms. In the magnetic layer, the contents of Co, Pt, Cr, and B are Co: 73 at %, Pt: 7 at %, Cr: 18 at %, and B: 2 at %.

The protection layer serves to prevent the magnetic layer from being deteriorated by contact with a magnetic head and comprises hydrogenated carbon having a thickness of 50 angstroms, providing wear resistance. The lubrication layer is formed by applying a perfluoropolyether liquid lubricant by dipping and has a thickness of 9 angstroms.

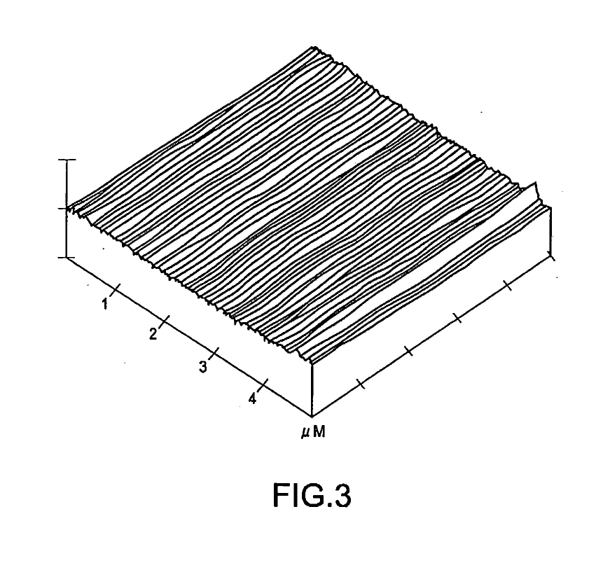

A fine profile of a principal surface of the magnetic disk thus obtained was observed in detail by the use of an AFM (atomic force microscope). As a result, a circumferential texture along a circumferential direction of the disk was observed. FIG. 2 shows a texture profile thereof. An observed region in FIG. 2 is a region of 5 μm×5 μm on the principal surface of the magnetic disk. Herein, the disturbance in texture profile as seen from FIG. 3 mentioned above was not observed.

The surface roughness of the texture obtained from the result of observation by the AFM was 4.57 nm in Rmax and 1.89 nm in Rp.

Next, the magnetic disk thus obtained was evaluated as follows.

[Evaluation of Magnetic Characteristic]

The magnetic characteristic was measured by VSM (vibrating sample magnetometry). A circular sample having a diameter of 8 mm was cut from the magnetic disk around a position of 22 mm in radius as a center. An external magnetic field was applied (±10 kOe) in each of a circumferential direction and a radial direction of the substrate to obtain a magnetization curve. Mrt (residual magnetization-thickness product) in the circumferential direction of the substrate and Mrt in the radial direction were calculated. As a result, the ratio of Mrt in the circumferential direction with respect to Mrt in the radial direction (magnetic anisotropy) was equal to 1.33.

[Evaluation of Reliability]

The magnetic disk thus obtained was evaluated for a glide characteristic. As a result, a touch down height was equal to 4.5 nm. The touch down height is a measure of an ability of the magnetic disk for a flying height by successively lowering the flying height of a flying head (for example, lowering the rotation speed of the magnetic head) and obtaining a particular flying height at which the head is first contacted with the magnetic disk. Generally, in a HDD required to have a recording density of 40 Gbit/in² or more, the touch down height must be equal to 5 nm or less.

Further, LUL durability was tested by repeatedly carrying out load/unload operations of the head at a flying height of 12 nm during flight of the head and under the environment of 70° C. and 80% RH. As a result, no head crash defect occurred even after the test of consecutive 600,000 times of LUL operations. It is said that, in a HDD generally used, about ten years of use will be required until the number of times of LUL operations exceeds 600,000. By the use of a GMR head having a flying height of 12 nm, a thermal asperity (TA) test was carried out. As a result, no thermal asperity defect occurred.

A surface of the magnetic head after the load/unload test mentioned above was observed by an optical microscope. As a result, no contamination was observed.

### EXAMPLE 2

In this example, a glass substrate for a magnetic disk was produced by a production method similar to that in Example 1 except that the tape used in (8) Tape Cleaning Step in Example 1 was replaced by a tape having a polyester surface similar to the tape used in the texturing polishing step. Further, by the use of the glass substrate, a magnetic disk was produced in the manner similar to Example 1.

A fine profile of a principal surface of the magnetic disk thus obtained was observed in detail by the AFM. As a result, a circumferential texture along a circumferential direction of the disk was observed like in FIG. 2. The surface roughness of the texture was obtained from the result of observation by the AFM and was equal to 4.96 nm in Rmax and 2.98 nm in Rp which were slightly greater as compared with Example 1.

The magnetic characteristic of the magnetic disk thus obtained was evaluated in the manner similar to Example 1. As a result, the oriented ratio was equal to 1.32.

Further, the glide characteristic was evaluated. As a result, the touch down height was equal to 4.8 nm.

The LUL durability was tested also. As a result, no head crash defect occurred even after a test of consecutive 600,000 times of LUL operations. A thermal asperity test was carried out. As a result, no thermal asperity defect occurred.

On a surface of the magnetic head after the load/unload test, adhesion of a very small amount of contamination was observed.

### EXAMPLE 3

In this example, the treating liquid used in (8) Tape Cleaning Step in Example 1 contained colloidal silica particles (concentration of 22 wt %) as colloidal particles. The colloidal silica particles had an average particle size of 0.15 μm. The treating liquid was adjusted to be alkaline with PH 10 by addition of sodium hydroxide (NaOH).

A glass substrate for a magnetic disk was produced by a production method similar to that in Example 1 except the above-mentioned respects. Further, by the use of the glass substrate, a magnetic disk was produced in the manner similar to Example 1.

A fine profile of a principal surface of the magnetic disk thus obtained was observed in detail by the use of the AFM. As a result, a circumferential texture along a circumferential direction of the disk was observed like in Example 1.

The magnetic characteristic of the magnetic disk thus obtained was evaluated in the manner similar to Example 1. As a result, the oriented ratio was 1.33.

The glide characteristic was evaluated. As a result, an excellent characteristic represented by the touch down height of 4.2 nm was obtained.

Further, the LUL durability was tested. As a result, no head crash defect occurred even after a test of consecutive 600,000 times of LUL operations. The thermal asperity test was carried out. As a result, no thermal asperity defect occurred.

A surface of a magnetic head after the load/unload test was observed by the optical microscope. As a result, no contamination was observed.

### EXAMPLE 4

In Example 4, a glass substrate for a magnetic disk was produced by a production method similar to that in Example 1 except that the scrub cleaning carried out in (8) Tape Cleaning Step in Example 1 by using the scrub pad after the tape cleaning was not carried out. Further, by the use of the glass substrate, a magnetic disk was produced in the manner similar to Example 1.

A fine profile of a principal surface of the magnetic disk thus obtained was observed in detail by the use of the AFM. As a result, a circumferential texture along a circumferential direction of the disk was observed like in Example 1. The surface roughness of the texture obtained from the result of observation by the AFM was 4.59 nm in Rmax and 1.85 nm in Rp. These values were substantially similar to those in Example 1.

The magnetic characteristic of the magnetic disk thus obtained was evaluated in the manner similar to Example 1. As a result, the oriented ratio was equal to 1.33.

Further, the glide characteristic was evaluated. As a result, the touch down height was equal to 4.8 nm.

The LUL durability was tested also. As a result, no head crash defect occurred even after a test of consecutive 600,000 times of LUL operations. The thermal asperity test was carried out. As a result, no thermal asperity defect occurred.

A surface of a magnetic head after the load/unload test was observed by the optical microscope. As a result, no contamination was observed.

### COMPARATIVE EXAMPLE 1

A glass substrate for a magnetic disk was produced by a production method similar to that in Example 1 except that (8) Tape Cleaning Step in Example 1 was not carried out. Further, by the use of the glass substrate, a magnetic disk was produced in the manner similar to Example 1.

A fine profile of a principal surface of the magnetic disk thus obtained was observed by the use of the AFM. As a result, a circumferential texture was observed. However, disturbance resulting from a texture profile on the surface of the glass substrate was observed as seen from FIG. 3 mentioned above. The surface roughness of the texture was 5.18 nm in Rmax and 3.30 nm in Rp. As compared with Example 1, Rp was degraded by 1.41 nm. This is because the texture profile was disturbed by a streak of texture higher than a surrounding texture profile like the one observed at a lower right portion in FIG. 3.

The magnetic characteristic of the magnetic disk thus obtained was evaluated in the manner similar to Example 1. As a result, the oriented ratio was equal to 1.32.

Further, the glide characteristic was evaluated. As a result, the touch down height was equal to 5.4 nm. The LUL durability was tested also. As a result, a failure occurred by head crash after 400,000 times of LUL operations. The thermal asperity test was carried out. As a result, a thermal asperity defect occurred also. On a surface of a magnetic head after the above-mentioned load/unload test, adhesion of contamination was observed.

### EXAMPLE 5

The tape used in (8) Tape Cleaning Step in Example 1 was replaced by a pile tape (trade name: SPD2501-NF). By the use of a glass substrate obtained, a magnetic disk was produced in the manner similar to Example 1.

A fine profile of a principal surface of the magnetic disk thus obtained was observed by the use of the AFM. As a result, a circumferential texture was observed. However, disturbance resulting from a texture profile on the surface of the glass substrate was observed as seen from FIG. 3 mentioned above. The surface roughness of the texture was 5. 02 nm in Rmax and 2.88 nm in Rp. As compared with Example 1, Rp was degraded. This is because the texture profile was disturbed by a streak of texture higher than a surrounding texture profile like the one observed at the lower right portion in FIG. 3.

The magnetic characteristic of the magnetic disk thus obtained was evaluated in the manner similar to Example 1. As a result, the oriented ratio was equal to 1.32.

Further, the glide characteristic was evaluated. As a result, the touch down height was equal to 4.9 nm. The LUL durability was tested also. As a result, a failure occurred by head crash after 400,000 times of LUL operations. The thermal asperity test was carried out. As a result, a thermal asperity defect occurred also. On a surface of a magnetic head after the above-mentioned load/unload test, adhesion of contamination was observed.

As described above in detail, in the method of producing a glass substrate for a magnetic disk according to this invention, the texture is formed on the principal surface of the glass substrate and thereafter the cleaning with the tape is carried out while supplying the treating liquid onto the principal surface. Thus, foreign matters and the like adhered to the principal surface of the substrate after forming the texture can be removed and the disturbance in texture profile is suppressed so as to form a uniform texture.

By producing a magnetic disk using the glass substrate for a magnetic disk according to this invention, it is possible to provide a magnetic disk which is capable of suppressing adhesion of contamination onto a magnetic head and preventing occurrence of a head crash defect and a thermal asperity defect against a reduction in flying height and which is high in reliability and suitable for a higher recording density.

What is claimed is:

1. A method of producing a glass substrate for a magnetic disk, comprising:
polishing a principal surface of a glass substrate to impart a texture thereon;
thereafter supplying a treating liquid onto the principal surface of the glass substrate; and
pressing a tape against the principal surface of the glass substrate and moving the glass substrate and the tape relative to each other to clean the principal surface.

2. A method of producing a glass substrate for a magnetic disk according to claim 1, wherein the treating liquid is pure water.

3. A method of producing a glass substrate for a magnetic disk according to claim 1, wherein the treating liquid contains colloidal particles.

4. A method of producing a glass substrate for a magnetic disk according to claim 1, wherein the tape for cleaning the principal surface of the glass substrate has small foaming pores at least on a surface of the tape.

5. A method of producing a glass substrate for a magnetic disk according to claim 1, wherein the glass substrate is a chemically strengthened glass substrate.

6. A method of producing a magnetic disk, wherein at least a magnetic layer is formed on a glass substrate for a magnetic disk obtained by the method according to claim 1.

7. A method of producing a glass substrate for a magnetic disk according to claim 1, wherein the glass substrate is used as a magnetic disk for a load/unload system.
